(19) United States
(12) Patent Application Publication
(10) Pub. No.: US 2002/0103768 A1
(43) Pub. Date: Aug. 1, 2002

(54) Secure payment system allowing selection of any payable amount

(76) Inventor: Alexandre Rado, Paris (FR)

Correspondence Address: SCHNADER HARRISON SEGAL & LEWIS, LLP, 1600 MARKET STREET, SUITE 3600, PHILADELPHIA, PA, 19103

(21) Appl. No.: 10/054,385

(22) Filed: Jan. 22, 2002

Related U.S. Application Data
(63) Continuation of application No. PCT/FR00/02117, filed on Jul. 21, 2000.

(30) Foreign Application Priority Data
Jul. 22, 1999 (FR) 9909538

(51) Int. Cl. G06F 17/60

(52) U.S. Cl. 705/75

(57) ABSTRACT

A process for payment of a selected amount by a payer with a payment card having a multiplicity of series of 10 boxes numbered from 0 to 9, associated with a monetary value, said boxes being covered before use by masking device which masks a unique code including removing selected portion of the masking device by selecting a number of units in corresponding boxes, communicating codes corresponding to the boxes whose masking device has been removed by the payer to a transaction receiving center for monetary payment verification.

### RELATED APPLICATION

This is a continuation of International Application No. PCT/FR00/02117, with an international filing date of Jul. 21, 2000, which is based on French Patent Application No. 99/09538, filed Jul. 22, 1999.

### FIELD OF THE INVENTION

This invention pertains to a secure payment system allowing selection of any payable amount.

### BACKGROUND

Numerous modes of payment are known in the state of the art. One of the problems is guaranteeing the authenticity of the payment. Traveler's checks, for example, have been proposed. In those payments, authenticity is guaranteed to a certain extent by anti-counterfeiting signs. However, that mode of payment is generally limited to predetermined amounts.

Sophisticated payment systems have been proposed, for example, bank cards and especially memory cards. However, of necessity, these systems require an intensive infrastructure with digital or analogue access to a server center that manages the transactions.

Also known is French patent FR 2,747,962 which describes an Internet payment system constituted by a support comprising at least one box to be scratched which conceals a secret number with each box corresponding to a predetermined amount.

It would accordingly be advantageous to provide a payment system which is not limited to predetermined amounts and which makes possible payments in complete security with very limited risks of fraud for both the merchant and the user.

### SUMMARY OF THE INVENTION

This invention relates to a process for payment of a selected amount by a payer with a payment card having a multiplicity of series of 10 boxes (6) numbered from 0 to 9, associated with a monetary value, said boxes being covered before use by masking device which masks a unique code including removing selected portion of the masking device by selecting a number of units in corresponding boxes, communicating codes corresponding to the boxes whose masking device has been removed by the payer to a transaction receiving center for monetary payment verification.

This invention also relates to a secure payment card including a support having a multiplicity of a series of 10 boxes numbered from 0 to 9, said series corresponding to base units and multiples thereof and each of said boxes having a unique code; and a mask which hides the codes, at least selected portions of the mask corresponding to selected boxes being removable to reveal a unique code corresponding to each box such that when selected portions of the mask are removed by a user to represent a selected numerical payment value, a third party, in possession of corresponding verification codes for the unique codes of the selected boxes, can verify the selected payment value.

This invention further relates to a secure payment system including a secure process for payment of a selected amount by a payer with a payment card including a support having a multiplicity of a series of 10 boxes numbered from 0 to 9, said series corresponding to base units and multiples thereof and each of said boxes having a unique code; and a mask which hides the codes, at least selected portions of the mask corresponding to selected boxes being removable to reveal a unique code corresponding to each box such that when selected portions of the mask are removed by a user to represent a selected numerical payment value, a third party, in possession of corresponding verification codes for the unique codes of the selected boxes, can verify the selected payment value ; and

a transaction center containing said verification codes which verifies the authenticity and coherence of the selected payment value.

### BRIEF DESCRIPTION OF THE DRAWINGS

Better understanding of the invention will be obtained from the attached drawings pertaining to a nonlimitative example of implementation in which:

FIG. 1 shows an expanded view of an example of implementation of a card according to the invention,

FIG. 2 shows a variant of implementation,

FIG. 3 shows the information flows.

### DETAILED DESCRIPTION

In a broad sense, the invention is a process for payment of a selected amount by a payer with a payment card having a multiplicity of series of 10 boxes (6) numbered from 0 to 9, associated with a monetary value, said boxes being covered before use by masking device which masks a unique code including removing selected portion of the masking device by selecting a number of units in corresponding boxes, the payment being communicating codes corresponding to the boxes whose masking device has been removed by the payer to a transaction receiving center for monetary payment verification.

Personal selection of the amount can also be constituted by the possibility of the payer to select the currency in which the payer wants the payment to be effected. The payment means preferably comprises a zone constituted by a series of numbered boxes for designating the number of uncovered payment boxes.

According to one variant, the payment means comprises a unique identification number of the payment means. According to a preferred mode of implementation, payment is implemented by communication of the codes corresponding to the boxes whose concealing and sealing means were removed by the payer and a personal identification number of the payer. According to one specific variant, the payment means comprises a series of boxes for designating the currency of the payment.

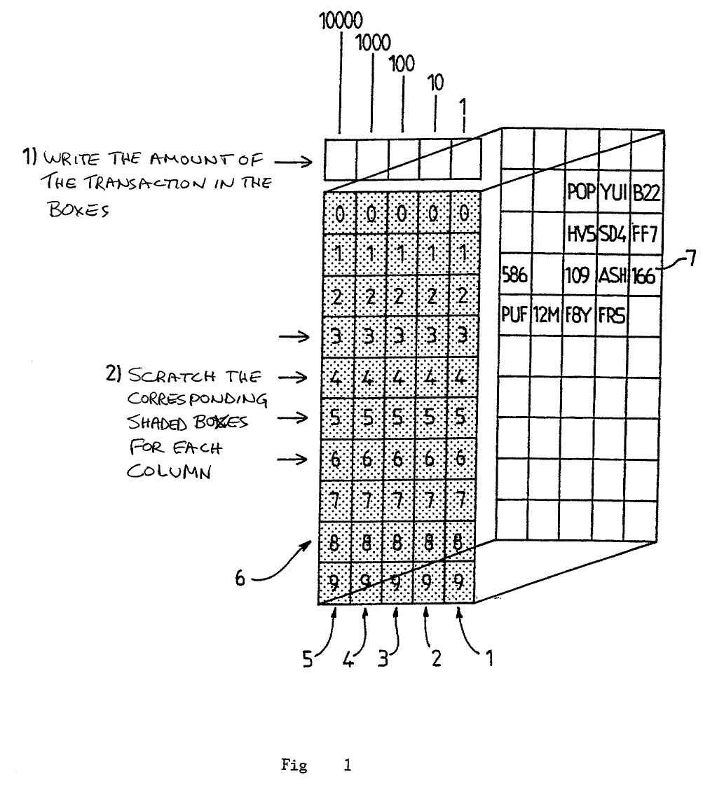

Turning now to the drawings, FIG. 1 shows an example of application of the payment means according to the invention. It is constituted of a card, for example, a form with the format of a check. It can be constituted by a rigid card made, for example, of cardboard or plastic, or by a sheet of paper or similar material.

It has on one of its surfaces 5 series of 10 boxes (6) numbered from 0 to 9. The first series (1) corresponds to the base units, the second series (2) corresponds to the “tens,” the third series (3) corresponds to the “hundreds,” the fourth series (4) to the “thousands” and the fifth series (5) to “tens of thousands.”

It can also comprise series corresponding to the decimals, for example, to cents and tens of cents.

Each of the boxes is covered by masking and sealing means bearing a number in order between 0 and 9. This masking and sealing means can be implemented by an adhesive tag or by a gum that can be peeled off by scratching.

The support is printed under each of these masking and sealing means with a unique code (7) specific to the corresponding box.

This code is, for example, a three-character alphanumeric code.

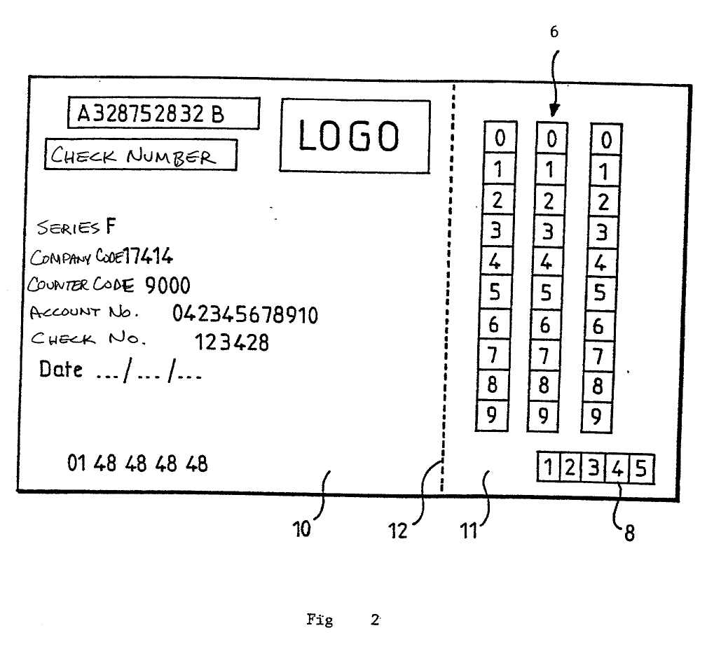

The card furthermore may comprise a zone (8) as shown in FIG. 2 constituted of a series of boxes of the same type as the previously mentioned boxes and corresponding to the number of activated boxes.

Another zone can comprise an identification number for the card during its use.

The beneficiary of the payment can write his identification number in a zone reserved for this purpose.

The use of the card is implemented in the following manner:

The payer takes an unused card.

1. The payer can write the amount of the transaction in a series of boxes located above or below the series of 10 boxes (6).

2. The payer scratches the shaded boxes corresponding to the increments of the amount in each series of 10 boxes (6), activating successively the box corresponding to the number of units in the amount to be paid, then activating the box corresponding to the number of tens in the amount to be paid, and so forth. If applicable, the payer can also activate the boxes corresponding to the decimals.

3. The payer then activates in zone (8) the box corresponding to the number of boxes activated in the payment zone.

4. The payer then presents this card to the merchant. The merchant transmits the codes appearing in the activated boxes to a transaction center by telephone, via the Internet, by fax, by telex or by any equivalent means of communication. It is not necessary for the merchant to have access to any specific communication equipment such as the payment terminal that is required for secure payment by a bank card.

The transaction center verifies the authenticity and coherence of the transmitted codes and as applicable, debits the payment, possibly communicating to the merchant a code sealing and authenticating the transaction.

The codes used are stored in memory by the transaction server to prevent implementation of a new payment using the same codes or using the codes of the same card.

For this purpose, the transaction center has a database in which are recorded the families of codes associated with each card issued. This database is also used for the manufacture of the cards to assure the uniqueness of the codes and the management of the attributed codes.

After validation of each card, the transaction center removes the codes of the boxes and the card used from the database of valid codes and identifiers.

According to one specific mode, an encryption algorithm is employed.

The card can have, as shown in FIG. 2, a stub (10) on which various information can be recorded such as a series code, a business code, a counter code, an account code, a payment means number, a position for recording the date of the transaction, the bank's telephone number as well as the transaction number received after the transaction, the amount, the merchant's identity, etc. The card is thus composed of a detachable coupon (11) and a stub (10) separated by a tear line (12). It may also bear a design or bank logo or any other means on the shaded parts to increase the security of the transaction.

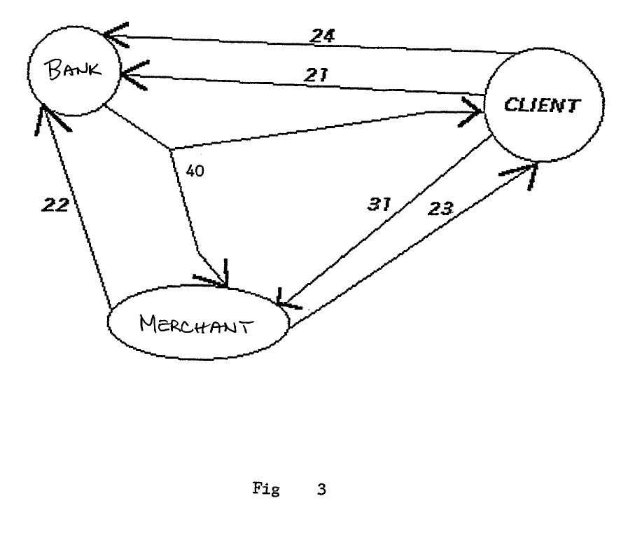

FIG. 3 shows the diagram of use for a transaction on a network.

Step 1: The client transmits the codes of the activated boxes:

to the bank (21),

to the merchant (31),

Step 2: The merchant then transmits its identification code to the bank (22) and to the client (23), adding to it the client's codes (21).

Step 3: The client transmits the merchant's code to the bank (24).

Step 4: The bank having received:

the client's codes and the merchant's code from the client,

and the same information from the merchant, verifies the validity of the transaction by comparing the codes with the information recorded in the database of valid codes. In the case of positive verification, the bank implements the financial transaction and invalidates the codes used for said transaction to prevent their subsequent reuse.

The bank can then inform (40) the client and the merchant that the transaction has been successfully implemented.

The invention is described above as a nonlimitative example.

The payment means could also be used for signing various documents, such as contracts or subscriptions, etc., with the content of the document to be signed being registered digitally by the control organism which then requests that the signatories uncover a certain code; by extension, the payment means can also be used for identification purposes and be used, for example, for voting.

The payment means can be in an electronic format, of credit card calculator type or in program software form.

There could be payment means in different amounts, similar to the case of normal credit cards, e.g., gold, platinum (registered trademark) with, for example, 5 columns 999.99 F or 7 columns 99999.99 F, etc.

1. A process for payment of a selected amount by a payer with a payment card having a multiplicity of series of 10 boxes numbered from 0 to 9, associated with a monetary value, said boxes being covered before use by a masking device which masks a unique code comprising removing selected portions of the masking device by selecting a number of units in corresponding boxes; and communicating codes corresponding to the boxes whose masking device has been removed by the payer to a transaction receiving center for monetary payment verification.

2. The process according to claim 1, wherein the card further comprises a zone having a series of numbered boxes for designation of a number of uncovered payment boxes.

3. The process according to claim 1, wherein the payment card has a unique identification number.

4. The process according to claim 1, wherein payment is implemented by communication of codes corresponding to boxes whose masking device were removed by the payer and a personal identification number of the payer.

5. The process according to claim 1, wherein the payment card has a series of boxes for designation of the type of currency of payment.

6. Means for payment of an amount which can be personalized comprising a card having a multiplicity of series of 10 boxes numbered from 0 to 9, said series corresponding to base units, tens, hundreds, thousands, tens of thousands, tenths and hundredths.

7. A secure payment card comprising:
a support having a multiplicity of a series of 10 boxes numbered from 0 to 9, said series corresponding to base units and multiples thereof and each of said boxes having a unique code; and
a mask which hides the codes, at least selected portions of the mask corresponding to selected boxes being removable to reveal a unique code corresponding to each box such that when selected portions of the mask are removed by a user to represent a selected numerical payment value, a third party, in possession of corresponding verification codes for the unique codes of the selected boxes, can verify the selected payment value.

8. The secure payment card according to claim 7, further comprising group of boxes corresponding to each of said series of boxes.

9. The secure payment card according to claim 7, wherein the unique codes are three character alphanumeric codes.

10. The secure payment card according to claim 7, wherein the multiples are selected from the group consisting of hundredths, tenths, tens, hundreds, thousands and tens of thousands.

11. A secure payment system comprising:
a secure payment card comprising: a support having a multiplicity of a series of 10 boxes numbered from 0 to 9, said series corresponding to base units and multiples thereof and each of said boxes having a unique code; and a mask which hides the codes, at least selected portions of the mask corresponding to selected boxes being removable to reveal a unique code corresponding to each box such that when selected portions of the mask are removed by a user to represent a selected numerical payment value, a third party, in possession of corresponding verification codes for the unique codes of the selected boxes, can verify the selected payment value; and
a transaction center containing said verification codes which verifies the authenticity and coherence of the selected payment value.

12. The secure payment system according to claim 11, wherein the transaction center debits payments for a user of the card.

13. The secure payment system according to claim 11, wherein the transaction center communicates with a merchant to verify a successful payment.
